(19) United States
(12) Patent Application Publication
(10) Pub. No.: US 2009/0270029 A1
(43) Pub. Date: Oct. 29, 2009

(54) VEHICULAR AUDIO/VISUAL SYSTEM AND METHOD OF CONTROLLING THE SAME

(76) Inventor: Takashi FUKUKAWA, Nishikamo-gun (JP)

Correspondence Address: KENYON & KENYON LLP, 1500 K STREET N.W., SUITE 700, WASHINGTON, DC, 20005, US

(21) Appl. No.: 12/343,697

(22) Filed: Dec. 24, 2008

(30) Foreign Application Priority Data
Dec. 26, 2007 (JP) 2007-334553

(51) Int. Cl. H04B 1/06

(52) U.S. Cl. 455/26.1

(57) ABSTRACT

A vehicular audio/visual system that receives a transmitted electric wave of video or sound, and that outputs the electric wave from an output unit includes: a positional information detecting unit that detects positional information of a vehicle; a receiving area storage unit that stores at least one of an allowable area in which receiving the electric wave is allowed and a prohibited area in which receiving the electric wave is not allowed; an allowable area determination unit that refers to the receiving area storage unit on the basis of the detected positional information and that determines whether receiving the electric wave is allowed; and a prohibiting unit that prohibits power supply to an antenna amplifier of an antenna that receives the electric wave or power supply to a tuner connected to the antenna, when it is determined that receiving the electric wave is not allowed.

### INCORPORATION BY REFERENCE

The disclosure of Japanese Patent Application No. 2007-334553 filed on Dec. 26, 2007 including the specification, drawings and abstract is incorporated herein by reference in its entirety.

### BACKGROUND OF THE INVENTION

1. Field of the Invention

The present invention relates to a vehicular audio/visual system that receives an electric wave of video or sound, transmitted from a broadcasting station, and outputs the electric wave from a display or a speaker and a method of controlling the vehicular audio/visual system and, more particularly, to a vehicular audio/visual system that prohibits output of video or music depending on an area, and a method of controlling the vehicular audio/visual system.

2. Description of the Related Art

Devices that display video may be installed in vehicles. Some regions or countries prohibit video display while running vehicles by regulations or laws so as not to interfere with driving. For this reason, vehicle manufacturers have been sometimes required to set running conditions, in which video display is prohibited, for each shipping destination country or region and then ship vehicles and audio/visual systems. However, the above setting increases costs, and vehicles move between countries or regions. Thus, depending on regulations or laws of destination countries or regions, setting at the time of shipment may possibly be inappropriate. Then, an on-board equipment function setting device has been suggested, for example, in Japanese Patent Application Publication No. 2003-78425 (JP-A-2003-78425), which detects the current position of a vehicle using a global positioning system (GPS) receiver and map data, compares the current position with a set table in which a video display prohibiting area is registered, and then prohibits video display.

Incidentally, video display includes media that are displayed by receiving a broadcast as in the case of television and media that are displayed by reproducing video stored in a DVD. In terms of this point, the on-board equipment function setting device described in JP-A-2003-78425 uniformly prohibits video display without taking a difference in media into consideration. Thus, the above on-board equipment function setting device is not able to differently handle video display even when provisions of laws or regulations are different among types of media. In addition, because the on-board equipment function setting device described in JP-A-2003-78425 just prohibits video display, prohibition of video display may possibly be cancelled by a modification performed by the occupant.

### SUMMARY OF THE INVENTION

The invention provides a vehicular audio/visual system that is able to further reliably prohibit output of a received broadcast depending on a current position, and a method of controlling the vehicular audio/visual system.

A first aspect of the invention provides a vehicular audio/visual system. The vehicular audio/visual system that receives an electric wave of video or sound, transmitted from a broadcasting station, and that outputs the electric wave from an output unit includes: a positional information detecting unit that detects positional information of a vehicle; a receiving area storage unit that stores at least one of an allowable area in which receiving the electric wave is allowed and a prohibited area in which receiving the electric wave is not allowed; an allowable area determination unit that refers to the receiving area storage unit on the basis of the detected positional information and that determines whether receiving the electric wave is allowed; and a prohibiting unit that prohibits power supply to an antenna amplifier of an antenna that receives the electric wave or power supply to a tuner connected to the antenna, when it is determined that receiving the electric wave is not allowed.

According to the above aspect, power supply to an antenna amplifier of an antenna or power supply to a tuner connected to the antenna is prohibited. Thus, the number of types of components is suppressed, an increase in cost is suppressed, and output of video or music may be reliably prohibited.

In the first aspect of the invention, the receiving area storage unit may store at least one of the allowable area in which receiving the electric wave is allowed and the prohibited area in which receiving the electric wave is not allowed, media by media. The media may include radio or television.

According to the above aspect, output of video or sound may be prohibited media by media.

In the first aspect of the invention, the receiving area storage unit may store at least one of the allowable area in which receiving the electric wave of a satellite radio broadcast is allowed and the prohibited area in which receiving the electric wave of the satellite radio broadcast is not allowed.

According to the above aspect, outputting audio of satellite radio may be prohibited depending on an area.

A second aspect of the invention provides a method of controlling a vehicular audio/visual system that receives an electric wave of video or sound, transmitted from a broadcasting station, and that outputs the electric wave from an output unit. The method includes: detecting a current position of a host vehicle; determining, on the basis of the detected current position, whether the host vehicle is within an area in which receiving the electric wave is allowed; and prohibiting power supply to an antenna amplifier of an antenna that receives the electric wave or power supply to a tuner connected to the antenna, when it is determined that the host vehicle is outside the area in which receiving the electric wave is allowed.

According to the above aspects, it is possible to provide a vehicular audio/visual system that is able to further reliably prohibit output of a received broadcast depending on a current position, and a method of controlling the vehicular audio/visual system.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a view that schematically shows satellite broadcasting;

FIG. 2 is an example of a schematic configuration diagram of an audio/visual system that includes an AV device and a navigation device;

FIG. 3A is an example of a functional block diagram of the AV device;

FIG. 3B is an example of a data structure of a receiving area database; and

FIG. 4 is a flowchart that shows steps in which the audio/visual system determines whether it is within the allowable area in which receiving a broadcast from a broadcasting satellite is allowed and prohibits power supply.

### DETAILED DESCRIPTION OF EMBODIMENTS

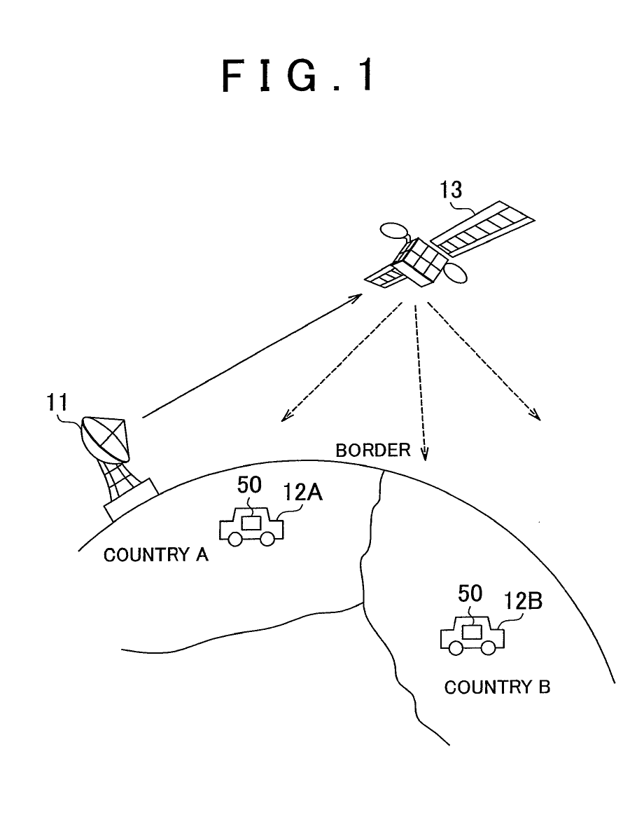

Hereinafter, embodiments according to the invention will be described with reference the accompanying drawings. FIG. 1 is a view that schematically shows satellite broadcasting. A broadcasting main station 11 transmits a digital signal, in which broadcasts of multiple channels are multiplexed, to a broadcasting satellite 13. The broadcasting satellite 13 is, for example, a geosynchronous satellite that synchronously orbits with respect to the earth or a quasi-zenith satellite that orbits along a locus inclined with respect to the equatorial plane. The broadcasting satellite 13 transmits an electric wave that carries a received data signal to the earth via a high-power transponder (repeater).

A vehicle 12A runs in a country A, and a vehicle 12B runs in a country B. The vehicles 12A and 12B are both within a broadcast area of the broadcasting satellite 13. Thus, audio/visual devices (hereinafter, referred to as AV devices) 50 of the vehicles 12A and 12B are able to receive an electric wave from the broadcasting satellite 13. However, output of video or music that is broadcast by the broadcasting satellite 13 may be prohibited in the country B or a provider of the broadcasting satellite 13 may prohibit output of video or music in the country B. In this case, it is undesirable that the AV device 50 of the vehicle 12B receives an electric wave from the broadcasting satellite 13 and outputs video or music.

Then, the AV device 50 according to the present embodiment stores beforehand an allowable area in which receiving a broadcast of the broadcasting satellite 13 is allowed (or a prohibited area in which receiving a broadcast of the broadcasting satellite 13 is prohibited) in correspondence with positional information, and determines, on the basis of the current position detected by a global positioning system (GPS), or the like, whether it is allowed to receive an electric wave from the broadcasting satellite 13. Then, the AV device 50 prohibits output of video or music, which is transmitted from the broadcasting satellite 13, unless it is within the allowable area. By so doing, the AV device 50 of the vehicle 12B is able to prohibit output of video or music, which is transmitted from the broadcasting satellite 13. The AV device 50 may prohibit receiving of an electric wave or may permit receiving but prohibit output of video or music; however, if the receiving of an electric wave itself is prohibited, it is possible to prevent the AV device 50 from being modified to output video or music that is broadcast by the broadcasting satellite 13.

Hereinafter, prohibition of receiving of a satellite radio will be described as an example; however, the aspects of the invention may also be applied to satellite television and may be applied to broadcasting of which the prohibited area is unevenly distributed, such as terrestrial television or terrestrial radio. Note that when the vehicles 12A and 12B need not be distinguished from each other, they are simply referred to as vehicle 12, and countries, regions, or the like, in which receiving is allowed are simply referred to as area.

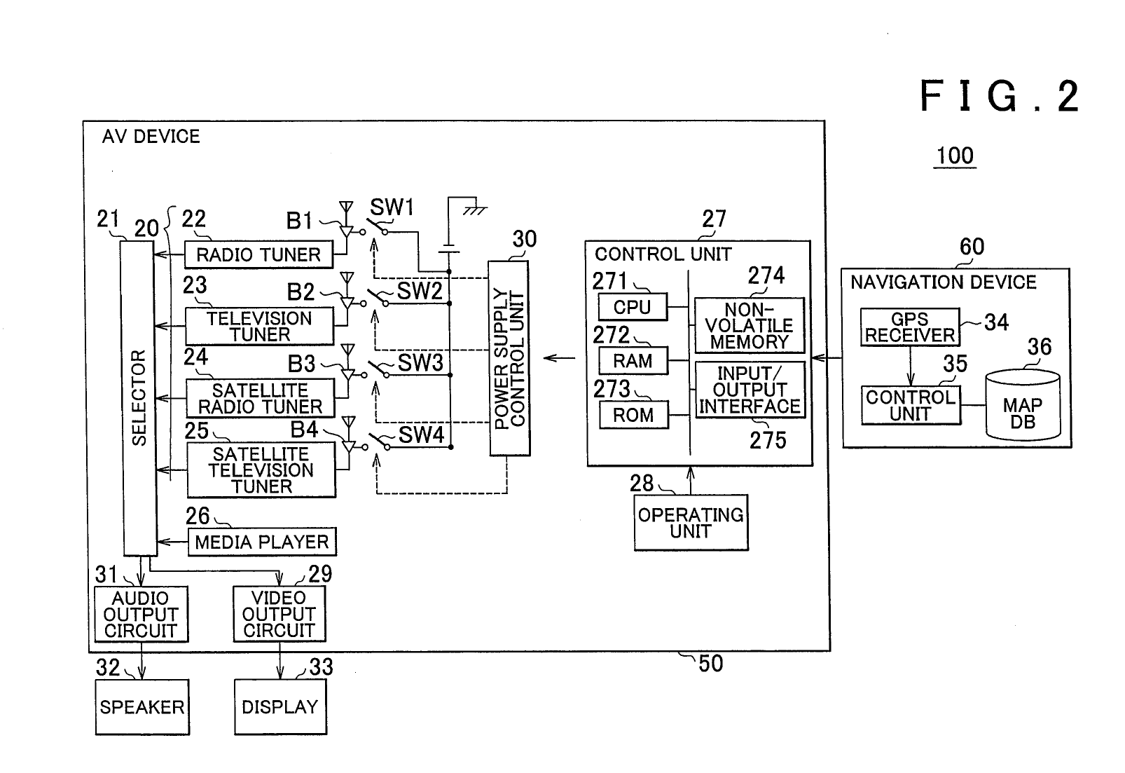

FIG. 2 shows an example of a schematic configuration diagram of an audio/visual system 100 that includes the AV device 50 and a navigation device 60. The AV device 50 is controlled by a control unit 27 that includes a computer in which a CPU 271, a RAM 272, a ROM 273, a non-volatile memory 274, an input/output interface 275, and the like, are connected via an internal bus. The control unit 27, when the user inputs an instruction through an operating unit 28, controls each block so as to perform an operation corresponding to the instruction, such as selection of a media source to be output from a speaker 32 and/or a display 33, selection of a channel, adjustment of volume, adjustment of sound quality, adjustment of video, switching a displayed image, such as a vehicle rear image, picked up by an on-board camera, or the like. In addition, the CPU 271 of the control unit 27 executes a program for implementing various functions, which will be described later.

The AV device 50 is able to select various types of media as a media source, such as terrestrial radio (analog or digital), terrestrial television (analog, digital, or one-segment), satellite radio (analog or digital), satellite television (analog or digital), or reproducing of a CD, DVD, or memory card. In correspondence with these functions, the AV device 50 includes a radio tuner 22, a television tuner 23, a satellite radio tuner 24, a satellite television tuner 25 (hereinafter, simply referred to as tuners 20 when it is not necessary to be distinguished from one another), and a media player 26.

In addition, the control unit 27 is connected to a power supply control unit 30 that controls power supplied to antenna amplifiers B1 to B4 of the tuners 20. The power supply control unit 30 separately controls on/off of switches SW1 to SW4 and separately controls power supplied to the antenna amplifiers B1 to B4 of the tuners 20. The antenna amplifiers B1 to B4 are one of boosters that amplify an electric wave received through an antenna.

Tuners of which the antenna amplifiers B1 to B4 are not supplied with power cannot receive an electric wave or can receive an electric wave but cannot amplify the electric wave and, therefore, cannot output audio or video from the speaker 32 or the display 33. According to the above way of prohibiting, the number of components and the number of types of components may be suppressed. Thus, it is possible to suppress an increase in costs. Note that power supplied to the media player 26 may also be prohibited.

By turning on/off the switches SW1 to SW4 for power supplied to the antenna amplifiers B1 to B4, power supplied to each of the tuners 20 is separately prohibited to make corresponding at least one of the tuners unable to start up. Thus, it is possible to avoid inconvenience that a system error occurs in the entire AV device 50, and it is possible to suppress an increase in costs of the AV device 50 of the present embodiment, which prohibits an electric wave from being received depending on a current position.

The radio tuner 22 or the satellite radio tuner 24 amplifies a digital radio signal, received through a given antenna, with the antenna amplifier B1 or B3 and then converts the amplified digital radio signal into an intermediate frequency signal (IF signal) with a mixer and a band-pass filter. Then, the intermediate frequency signal is detected and demodulated, and converted into a time division multiplexing (TDM) bit stream, and then data of a predetermined channel is extracted. The extracted data include audio data of a program (on-air program on the predetermined channel) provided for the user, label data attached to the program, and label data of other channels (other programs). The radio tuner 22 or the satellite radio tuner 24 converts the audio data of the receiving channel into a digital audio signal with an audio decoder and inputs the digital audio signal to a selector 21. The digital audio signal output from the selector 21 is converted into an analog audio signal (D/A conversion) by an audio output circuit 31, and then the analog audio signal is amplified and output from the speaker 32.

In addition, the radio tuner 22 or the satellite radio tuner 24 decodes the label data of the receiving channel into character string data and sends the character string data to the selector 21. The character string data is output from a video output circuit 29 to be displayed on the display 33. The label data include program information of multiple channels in time sequence, so that the occupant may select a desired radio program. Note that the radio tuner 22 or the satellite radio tuner 24 may be an analog tuner.

The television tuner 23 or the satellite television tuner 25 amplifies a digital television signal of a digital television broadcast, received through an antenna, with the antenna amplifier B2 or B4, and converts the amplified digital television signal into an intermediate frequency signal that includes a target channel with a synthesizer tuner circuit. Then, the intermediate frequency signal is decoded, and digital data in MPEG2 format are extracted. After that, video and audio data stream of the target channel are decoded from the extracted digital data. The decoded original digital video signal is output to the selector 21 and is displayed on the display 33 by the video output circuit 29.

Furthermore, the decoded original digital audio signal is supplied to the audio output circuit 31 via the selector 21, converted from the digital signal into an analog signal (D/A conversion) and amplified, and then output from the speaker 32. Note that the television tuner 23 or the satellite television tuner 25 may be an analog tuner.

The media player 26 reads a digital signal from a CD, DVD, or memory card, which is set through a predetermined insertion port, decodes a video signal such as MPEG2 and an audio signal such as PCM, and then outputs the decoded signals to the selector 21. The audio output circuit 31 converts the digital audio signal into an analog audio signal (D/A conversion), amplifies the analog audio signal, and outputs the amplified analog audio signal from the speaker 32. In addition, the video signal output from the selector 21 is displayed on the display 33 by the video output circuit 29.

The operating unit 28 includes, for example, a touch panel integrated with the display 33, a voice input unit, a keyboard, a button, or the like. The operating unit 28 allows the occupant to input an instruction, such as selection of a media source, switching of a channel, input of a destination of the navigation device 60, which will be described later.

The control unit 27, for example, displays, on the display 33, a human-machine interface (HMI) for selecting a media source (hereinafter, referred to as source selection HMI) or an HMI for selecting a channel (hereinafter, referred to as program selection HMI). Then, as a media source or a channel is selected through the operating unit 28, the control unit 27 controls the power supply control unit 30 on the basis of occupant's instruction to turn on one of the switches SW1 to SW4 to supply power to the corresponding one of the antenna amplifiers B1 to B4 of the tuner 20 corresponding to the selected media source, and switches the circuit of the selector 21.

Note that the control unit 27 may display the type of an output media source or the status of operation, such as receiving sensitivity, on the display 33. In addition, an external reproducing device and the AV device 50 may be connected through a cable or wireless communication and output from the speaker 32 and the display 33.

The navigation device 60 includes a GPS receiver 34, a map data base (DB) 36, and a control unit 35. The GPS receiver 34 acquires positional information of the vehicle 12 on the basis of an electric wave received from a GPS satellite. The map DB 36 stores road map information in correspondence with positional information. The control unit 35 controls the navigation device 60. As the navigation device 60 starts up, the control unit 35 extracts road map information from the map DB 36 on the basis of the positional information acquired by the GPS receiver 34, generates drawing information to be displayed on the display 33 on the basis of the road map information, and sends the generated drawing information to the AV device 50 with a mark that indicates a host vehicle position, an icon that indicates a gas station, or the like, being superimposed on the generated drawing information. In addition, when a destination is input from the operating unit 28, the control unit 35 searches a route from a current position to the destination, and guides the occupant to the destination by, for example, highlighting the route in the drawing information or generating voice information output from the speaker 32 just before turning right or left. Note that in FIG. 2, the AV device 50 and the navigation device 60 are separately shown; they may be integrally formed, instead.

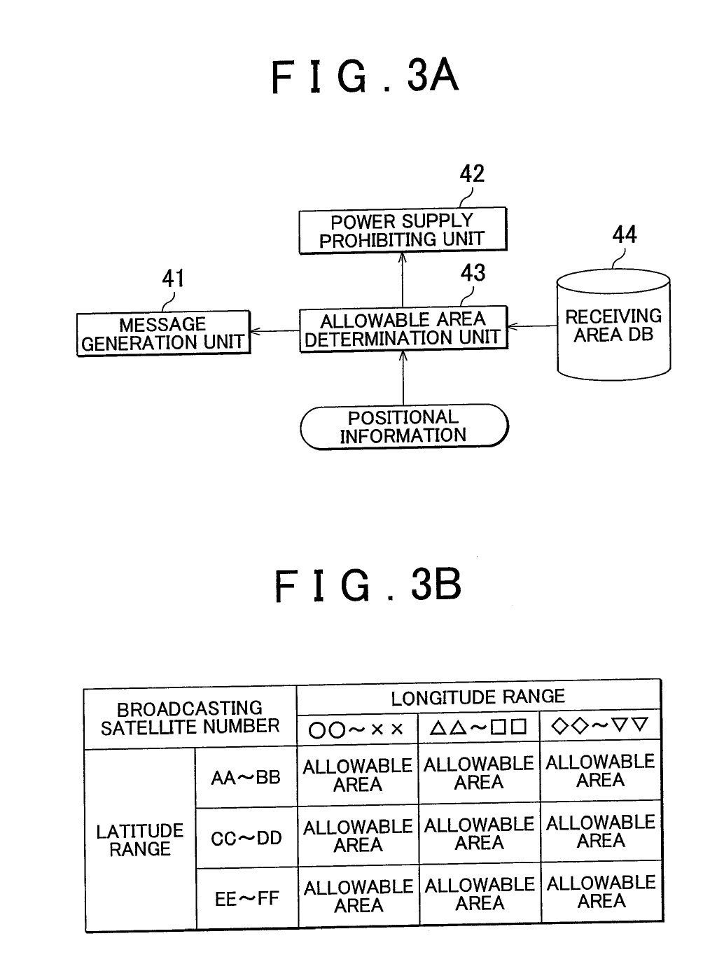

FIG. 3A shows an example of a functional block diagram of the AV device 50. The control unit 27 of the AV device 50 includes a message generation unit 41, a power supply prohibiting unit 42 and an allowable area determination unit 43, which are implemented in such a manner that the CPU 271 executes a program. The control unit 27 stores a receiving area DB 44 in the non-volatile memory 274.

The allowable area determination unit 43 refers to the receiving area DB 44 on the basis of the positional information acquired by the GPS receiver 34, and determines whether the current position is within the allowable area in which receiving satellite radio that is broadcast by the broadcasting satellite 13 is allowed. Thus, an area in which receiving is allowed is registered in the receiving area DB 44 in correspondence with positional information.

FIG. 3B shows an example of a data structure of the receiving area DB 44. A manufacturer of the vehicle 12 or AV device 50 knows the area in which receiving is allowed and coordinates (latitude and longitude) of the area. The receiving area DB 44, for example, specifies an area, in which receiving is allowed, with a latitude range and a longitude range for each broadcasting satellite number that identifies the broadcasting satellite 13 of satellite radio. Thus, when the current position is included in the area in which receiving is allowed, it is possible to receive a broadcast of the broadcasting satellite 13. Note that an area in which receiving is not allowed may be specified with a latitude range and a longitude range, or both the area in which receiving is not allowed and the area in which receiving is allowed may be registered. By registering only the area which has the smaller number of areas to be registered in the receiving area DB 44, it is possible to reduce the storage capacity of the non-volatile memory 274. Note that the status in which receiving is allowed or receiving is prohibited may be registered in the receiving area DB 44 in correspondence with a link number of a road.

The receiving area DB 44 may be stored in the non-volatile memory 274 at the time of shipment of the vehicle 12 or AV device 50. When the vehicle 12 is shipped to a region including countries or areas in which receiving a broadcast of the broadcasting satellite 13 is not allowed, an area other than the above area in which receiving is not allowed is registered in the receiving area DB 44 as the area in which receiving is allowed.

In addition, the vehicle 12 establishes connection with a network through a cellular phone network, a wireless LAN, or the like, to communicate with a predetermined server, and is always able to update the registration information of the receiving area DB 44. Thus, even when the provider of the broadcasting satellite 13 or the policy of a country is changed to change the area in which receiving is allowed, by updating the receiving area DB 44 via a server, it is possible to prevent a situation in which satellite radio is received in an area in which receiving is not allowed or satellite radio cannot be received in an area in which receiving is allowed.

Note that FIG. 3B shows allowable areas in which receiving satellite radio that is broadcast by the broadcasting satellite 13 is allowed; however, if similar allowable areas are registered respectively for satellite television, terrestrial television, terrestrial radio, the media player, and the like, it is possible to prohibit output depending on an area media by media.

Referring back to FIG. 3A, the power supply prohibiting unit 42 prohibits the power supply control unit 30 from supplying power to the antenna amplifier B3 of the satellite radio tuner 24 on the basis of the result of determination of the allowable area determination unit 43. Thus, even when the occupant operates the operating unit 28 to start up the satellite radio tuner 24, an electric wave received by the satellite radio tuner 24 is not amplified and, as a result, audio will not be output from the speaker 32.

The message generation unit 41 generates a message to be displayed on the display 33 or to be output from the speaker 32 when the occupant operates the operating unit 28 to attempt to start up the satellite radio tuner 24. For example, the message generation unit 41 generates a message that “running in the area in which receiving of satellite radio is prohibited” and outputs the message from at least one of the speaker 32 and the display 33. Thus, it is possible to notify the occupant why satellite radio cannot be listened to.

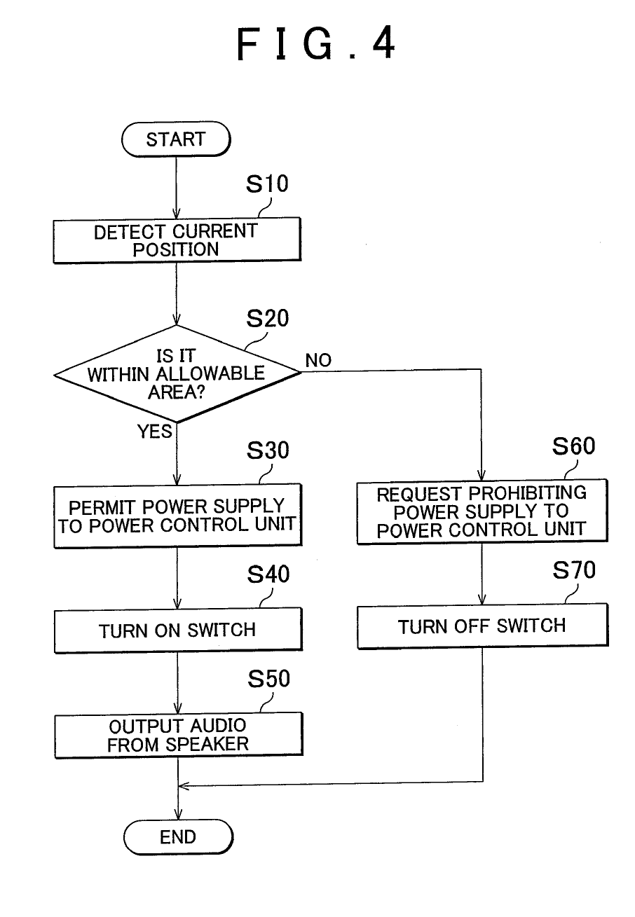

FIG. 4 is a flowchart that shows steps in which the audio/visual system 100 determines whether it is within the allowable area in which receiving an electric wave from the broadcasting satellite 13 is allowed and prohibits power supply. The flowchart of FIG. 4 is, for example, executed repeatedly at predetermined time intervals.

When the ignition is turned on and while the vehicle is running, the navigation device 60 detects the current position by the GPS receiver 34 (S10). The allowable area determination unit 43 of the AV device 50 refers to the receiving area DB 44 on the basis of the acquired current position, and determines whether the current position is within the allowable area in which receiving an electric wave from the broadcasting satellite 13 is allowed (S20). Note that the allowable area determination unit 43 stores the result of determination in the RAM 272 or in the non-volatile memory 274. By so doing, it is not necessary to repeatedly determine whether it is within the allowable area.

When the current position is within the allowable area (Yes in S20), the control unit 27 permits the power supply control unit 30 to supply power (S30). By so doing, when the occupant operates the operating unit 28 to start up the satellite radio tuner 24, the power supply control unit 30 is able to turn on the switch SW3 (S40) to supply power to the antenna amplifier B3 for the satellite radio tuner 24. As the antenna amplifier B3 is supplied with power, sound of satellite radio is output from the speaker 32 (S50).

When the current position is outside the allowable area (No in S20), the power supply prohibiting unit 42 prohibits the power supply control unit 30 from supplying power to the antenna amplifier B3 for the satellite radio tuner 24 (S60). By so doing, even when the occupant operates the operating unit 28 to attempt to start up the satellite radio tuner 24, the power supply control unit 30 is prohibited from turning on the switch SW3 (S70). Note that when the vehicle 12 enters from the allowable area into an area outside the allowable area, and when the satellite radio tuner 24 has been already started up (when power is being supplied to the antenna amplifier B3), the power supply control unit 30 forcibly turns off the switch SW3.

When the occupant operates the operating unit 28 to attempt to start up the satellite radio tuner 24 or when the switch SW3 is forcibly turned off, the control unit 27 outputs a message, generated by the message generation unit 41, from the display 33 to notify the occupant that the vehicle 12 is running in an area in which receiving of satellite radio is prohibited.

According to the present embodiment, because power supply to the antenna amplifier B3 for the satellite radio tuner 24 is prohibited in the area in which receiving the satellite radio is prohibited, it is possible to reliably prohibit satellite radio from being received in the area in which receiving is prohibited. Because an electric wave is not amplified (or an electric wave cannot be received), it is possible to make it difficult to listen to the satellite radio even with a modified AV device 50.

Note that in the present embodiment, prohibiting power supply to the antenna amplifier B3 is illustrated as an example; instead, power supply to the satellite radio tuner 24 may be prohibited.

In addition, output of the satellite radio tuner 24 may be prohibited without controlling power supply to the satellite radio tuner 24 or to the antenna amplifier B3. For example, when the allowable area determination unit 43 determines that receiving is not allowed at the current position, the control unit 27 does not display a choice for satellite radio on a source selection HMI. In the case where a media source is selected only through a touch panel, when no choice for satellite radio is displayed on the source selection HMI, it is possible to prohibit satellite radio from being listened to.

In addition, when a choice for satellite radio, displayed on the source selection HMI, is selected by the occupant or the occupant is able to directly select satellite radio through a button of the operating unit 28, the control unit 27 may be prohibited from switching the circuit of the selector 21 to the satellite radio tuner 24. Because the selector 21 is not switched, even when an electric wave is received from the broadcasting satellite 13, it is possible to prevent output from the speaker 32.

What is claimed is:

1. A vehicular audio/visual system that receives a transmitted electric wave of video or sound, and that outputs the transmitted electric wave from an output unit, comprising:
a positional information detecting unit that detects positional information of a vehicle;
a receiving area storage unit that stores at least one of an allowable area in which receiving the electric wave is allowed and a prohibited area in which receiving the electric wave is not allowed;
an allowable area determination unit that refers to the receiving area storage unit on the basis of the detected positional information and that determines whether receiving the electric wave is allowed; and
a prohibiting unit that prohibits power supply to an antenna amplifier of an antenna that receives the electric wave or power supply to a tuner connected to the antenna, when it is determined that receiving the electric wave is not allowed.

2. The vehicular audio/visual system according to claim 1, wherein
the receiving area storage unit stores at least one of the allowable area in which receiving the electric wave is allowed and the prohibited area in which receiving the electric wave is not allowed, media by media.

3. The vehicular audio/visual system according to claim 2, wherein
the media includes radio or television.

4. The vehicular audio/visual system according to claim 2, wherein
the receiving area storage unit stores at least one of the allowable area in which receiving the electric wave of a satellite radio broadcast is allowed and the prohibited area in which receiving the electric wave of the satellite radio broadcast is not allowed.

5. The vehicular audio/visual system according to claim 1, wherein
the receiving area storage unit stores at least one of the allowable area in which receiving the electric wave of a satellite radio broadcast is allowed and the prohibited area in which receiving the electric wave of the satellite radio broadcast is not allowed.

6. The vehicular audio/visual system according to claim 1, further comprising:
an operating unit through which a user inputs an instruction, wherein
the operating unit generates an operation menu that does not display an icon by which an instruction for outputting the electric wave is input, when it is determined that receiving the electric wave is not allowed.

7. A method of controlling a vehicular audio/visual system that receives a transmitted electric wave of video or music, and that outputs the transmitted electric wave from an output unit, comprising:
detecting a current position of a host vehicle;
determining, on the basis of the detected current position, whether the host vehicle is within an area in which receiving the electric wave is allowed; and
prohibiting power supply to an antenna amplifier of an antenna that receives the electric wave or power supply to a tuner that is connected to the antenna, when it is determined that the host vehicle is outside the area in which receiving the electric wave is allowed.

8. The method of controlling the vehicular audio/visual system according to claim 7, further comprising:
notifying a user that output of the electric wave is not allowed, when power supply to the antenna amplifier or power supply to the tuner is prohibited.
